(19) United States
(12) Patent Application Publication
(10) Pub. No.: US 2024/0152412 A1
(43) Pub. Date: May 9, 2024

(54) STATEFUL FUNCTION-AS-A-SERVICE (FAAS) FOR THE EDGE

(71) Applicant: Dell Products L.P., Round Rock, TX (US)

(72) Inventors: Trevor Scott Conn, Leander, TX (US); Joel Christner, El Dorado Hills, CA (US)

(21) Appl. No.: 18/053,911

(22) Filed: Nov. 9, 2022

(51) Int. Cl. G06F 9/54

(52) U.S. Cl. CPC G06F 9/543

(57) ABSTRACT

One method includes receiving a user-defined function, generating a binary based on the user-defined function, copying the binary to a target host where the user-defined function will run, in response to a lookup request, received from an API gateway based on a function invocation by a user, looking up the target host and a route, and returning, to the API gateway, a target host ID and the route, so as to enable the API gateway to request the target host to respond to the function invocation.

### FIELD OF THE INVENTION

Some embodiments of the present invention generally relate to edge computing systems and processes. More particularly, at least some embodiments of the invention relate to systems, hardware, software, computer-readable media, and methods, for defining and implementing functions by way of FaaS (Function as a Service) as related, stateful behaviors for one or more edge computing entities.

### BACKGROUND

Edge computing environments may include a variety of edge devices, such as IoT (Internet of Things) devices for example. The edge devices may communicate, and interoperate, with a central entity of some kind in order that the edge devices and central entity can collectively effect the performance of various functions. Increasing attention is being given to various ways in which such functions may be provided, executed, and consumed.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses deployment of user-defined function via fabric manager, according to one embodiment.

FIG. 2 discloses user/client issuing functions through the API gateway, according to one embodiment.

FIG. 3 discloses a comparative example of an FaaS execution workflow.

FIG. 4 discloses a decentralized execution model according to one embodiment.

FIG. 5 discloses a process for defining software dependencies for stateful entity type, according to one embodiment.

FIG. 6 discloses a process for defining the stateful entity type itself, according to an embodiment.

FIG. 7 discloses a process for defining a function for the stateful entity, according to an embodiment.

FIG. 8 discloses a process for onboarding an entity of type “boiler” on a given host, according to an embodiment.

FIG. 9 discloses an example method according to an embodiment.

FIG. 10 discloses a physical computing entity operable to perform any of the disclosed methods, processes, and operations.

### DETAILED DESCRIPTION OF SOME EXAMPLE EMBODIMENTS

Some embodiments of the present invention generally relate to edge computing systems and processes. More particularly, at least some embodiments of the invention relate to systems, hardware, software, computer-readable media, and methods, for defining and implementing functions by way of FaaS (Function as a Service) as related, stateful behaviors for one or more edge computing entities.

A Function-as-a-Service (FaaS) platform may be constructed that involves the use of functions that are discrete, stateless units of work without any relationship to one another. In contrast however, an embodiment of the invention may provide the capability to define functions via FaaS as related, stateful behaviors for a given entity, much like methods on a class. Further, the approach taken by some embodiments to FaaS may target function deployment at the edge, on the devices where the actual work is happening. Functions deployed in this manner may be stateful, operating with awareness of the local state of the device on which the function is deployed. As disclosed herein, local state awareness may be particularly useful in some contexts.

Note that as used herein, an “entity” refers to a software-defined representation of a physical thing. Further, reference is also made herein to a “host,” that is, a physical thing. In an example use case discussed herein, a host takes the form of a compute-enabled boiler with resources to run an application, the “entity,” that is able to represent the boiler state virtually.

In general, some example aspects of one embodiment of the invention may be illustrated using the example of a boiler such as may be employed on a ship, or in a building, for example. It is noted that the reference to a boiler is solely for the purposes of illustration and is not intended to limit the scope of the invention in any respect. For the purposes of illustration, the boiler may comprise an edge device in an edge computing environment.

In this example, a developer may define a given entity type, such as a boiler, and then defines function, or behaviors, to be associated to that entity. The functions may operate on local state within that device. One example function may be a function which obtains a temperature reading of the boiler. Each function may comprise a stand-alone application deployed to the target host, that is, the boiler in this example, and served on a unique port. A fabric manager may be provided by an embodiment and is responsible for receiving the developer function code and merging that function code into a template which may then be compiled into an executable, that is, executable code. That executable may then be deployed to a host, such as the boiler, that has been onboarded, by the fabric manager into the fabric, and that announced itself as an entity of a certain type, a boiler in this example.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that a function may run locally at an edge device and thereby avoid latency problems otherwise likely to be experienced if the function were centrally hosted and then called by the edge device. As another example, in an embodiment, a function may utilize local state at the device where the function is running. An embodiment may enable the addressing of an edge device even if the physical location of the edge device may be unknown. As a final example, an embodiment may avoid the need for scaling solutions associated with configurations in which the hosting and execution of functions is performed in a centralized manner. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

Some example embodiments of the invention are directed to structures and operations by way of which FaaS may operate to deploy and operate at a compute-enabled functional edge. Elements, features, and functions, of some embodiments may include, but are not limited to, any one or more of the following:
ability to uniquely address a given device through an ID;
ability to define and deploy new functional capabilities targeting a given device dynamically;
ability to hide the complexity of device locality from clients/users who might wish to invoke a given function, that is, a client/user need not know, for example, the physical location of the device, or hostname, in order to invoke a function operating at that device;
ability to handle local state within a given function; and
when onboarding a new device of known type, enabling that device to pro-actively receive all existing functions that could be invoked.

In a contrasting type of FaaS platform, functions are discrete, stateless units of work without any relationship to one another. Additionally, such FaaS platforms are deployed in a hub-and-spoke model whereby the function execution happens at the hub with calling applications being the spokes. In the case of an edge deployment, the execution of the function is happening at some other location relative to the edge device.

However, the edge device is where the actual field work is being performed and is the source of truth with regard to state, for example, a video camera providing a live stream, or, a sensor measuring temperature. Thus, one or more embodiments of the invention may define a system and method that may include, but are not limited to, the following:
registration of target edge devices of a given type;
creation of new device types and functions for those device types;
supplying registered devices with a set of functions that can be invoked upon them based on their type, wherein those functions can utilize local state on the device; and
facilities for addressing target edge devices by identifier, without regard to their physical location.

One aspects of some embodiments is their ability to uniquely address target devices in the field so that the functional capabilities at the host can be invoked. Further, an embodiment may operate to hide the complexity of the location of target devices from applications or users invoking functions on the device. Thus, embodiments may implement these aspects by defining functions via FaaS as behaviors on a given entity, much like methods on a class. A pseudo-code example that might be used to get/set temperature on a specific boiler with ID 123 may be as follows:
Boiler(123).getTernperature( )
Boiler(123).setTemperature( )

Implementing functions for new behaviors may, in some embodiments at least, be performed on the fly through a UI (user interface) or through an API (application program interface). New functions may be deployed and activated by the platform without a restart of the target device. As well, function definition may include identifying the entity type to which it belongs, the appropriate routing segment and potentially the relevant HTTP verbs for each function. These elements may be needed for RESTful invocation.

To simplify mapping of addressability to physical device locality, an application fabric manager may keep track of where the instances of a given entity are located and the relevant connectivity. An API gateway may provide RESTful semantics for clients or users that wish to invoke functions hosted on these devices. The API gateway is the entry into the application fabric which may parse the HTTP request, identify the appropriate route, and determine which entity is being addressed. Further, the combined route and HTTP verb, such as the GET and PATCH examples below, may serve to indicate which function is being called. Given the get/set temperature example above, corresponding calls to the API gateway to invoke those functions may be as follows:
GET http://example.org/instance/boiler/123/temperature
PATCH http://example.org/instance/boiler/123/temperature (including a request body identifying the desired temperature).

### B. Illustrative Aspects of Some Example Embodiments

As noted earlier, one or more embodiments may comprise methods and mechanisms configured and operable to run stateful FaaS capabilities at the functional edge. As well, some embodiments may be configured and operable to make those functions easily callable.

Because some embodiments may provide for the running of stateful FaaS capabilities at the functional edge, such embodiments may avoid the problems that may be experienced by FaaS platforms that have been built on cloud native principles. Due to the ephemeral nature of services running in the cloud, it is considered by some to be a best practice to ensure, in such FaaS platforms, that a given service or function is stateless. This means that the service has no long-lived state in memory, or in a fixed location, such as a local filesystem or statically addressable host database.

On the other hand, because some embodiments implement FaaS at the edge, it may be important in such embodiments to consider, and include, state in such implementations. For example, in some embodiments, functions may need to interrogate the state of the device on which they execute or otherwise evaluate ingested data relative to other conditions in the device operating context. To return to the example of boilers, state information may be needed to determine various conditions of the boiler at one or more particular points in time. This determination would be difficult, or impossible, if only stateless functions were employed. Finally, to reduce latency, embodiments may operate on that state locally and avoid multiple round-trip exchanges with another host somewhere else on the network.

Another aspect of some embodiments is that they may operate to simplify the details of distributed edge topology for ease of function invocation. Edge deployments can be quite complex with many different devices connected in a distributed topology. To invoke commonly-defined software capabilities across a wide swath of hosted entities and types, it can be cumbersome to require the calling application or user to know where a given instance of boiler “123” physically resides. Thus, some embodiments provide a scheme that is able to address the device simply by the device ID, and then have the supporting software infrastructure perform the translation of the ID to the specific device to which the ID corresponds.

Some embodiments may enable the definition and use of functions defined in current as-a-service platforms that are related to one another. By way of contrast, another FaaS allow a developer to define functions as discrete units of functionality, but those functions bear no relationship to one another because the platform semantics are lacking if one wishes to create a group of functions that clearly describe and are related to a given entity or type.

One or more embodiments may provide for FaaS execution on the actual device where the work relating to the function is being performed. To continue with the boiler example, a function to obtain boiler temperatures may run at the boiler where the temperatures are being monitored and recorded. This approach may be advantageous over one in which FaaS execution occurs on a host that is remote from the device where the work is being performed, since the need for that device to make function calls to a central host may be avoided. By eliminating the need for these calls, the function may run in a stateful manner at the device, and latency between the device and a central host may be avoided.

Further, an embodiment may avoid the need for containers and associated orchestration layers. This may be particularly useful, given the constrained compute and storage footprint of many functional edge devices. More particularly, embodiments may comprise approaches for deploying functions to edge devices without demanding overhead from containers or virtualization.

### C. Detailed Description of Some Example Embodiment

Some example embodiments may comprise two applications, namely, a fabric manager, and an API gateway. In general, one or more embodiments of the fabric manager may provide an API that supports operations that include, but are not limited to: enabling a developer to define the desired functions and the stateful types to which they belong; onboarding of new devices as hosts for function; queryable endpoints showing all hosts participating in the fabric and their corresponding entity instances; and translation of a given function invocation to its stateful location in the fabric. In general, a role of one or more embodiments of the API gateway is to accept requests from clients/users and to translate those requests into remote function invocations applicable to an entity instance on a given host.

Operationally, a method according to some embodiments may proceed as follows. A developer may define a given entity type, such as a boiler for example, and then define functions, or behaviors, associated to that entity which operate on local state within the host where the entity is located. Thus, a particular temperature reading for a boiler may define the state within the boiler. Each function may be a stand-alone application deployed to the target host, the boiler in this example, and served on a unique port. The fabric manager may be responsible for receiving function code from the developer and merging the function code with a template which can then be compiled into an executable. That executable may then be deployed to a host that has onboarded into the fabric and announced itself as an entity of a certain type, such as a boiler, for example.

### C.1 general aspects of function definition and deployment

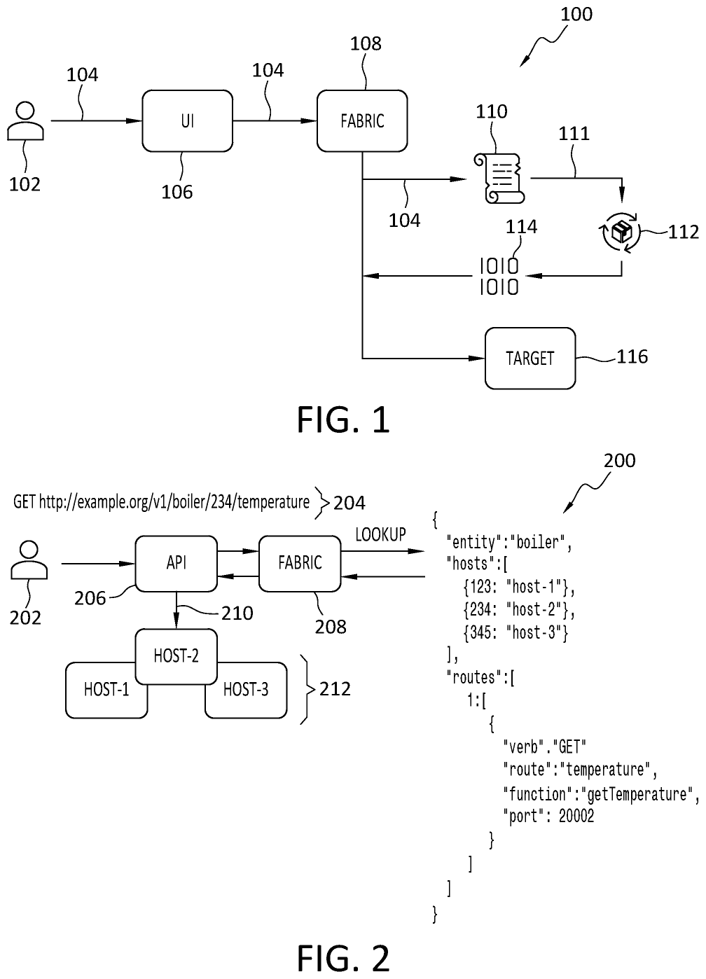

With reference now to FIG. 1 there is disclosed a configuration for definition and deployment of a user-defined function by way of a fabric manager. Particularly, in the configuration 100, a user 102 may submit their function 104, by way of a UI 106, to a fabric node 108. The fabric node 108 may then merge the function 104 into a script template 110 that may contain a basic application hosting a web server. The script template 110 may be modified to include the supplied function 104, and a handler may be wired to a user-specified route. That is, the fabric node 108, or another part of a fabric, may comprise code that maps the function 104 to a particular handler. The modified code 111 may then be compiled 112, and the resulting binary 114 then copied to the relevant target device(s) 116, such as a boiler or other IoT device for example. Having thus defined these capabilities, clients/users then need a way to invoke the functions without worrying about routing details of entities that may be spread out over a distributed topology. This is a role facilitated by the API gateway.

With reference now to FIG. 2, there is disclosed a configuration 200 in which a user/client issues functions through an API gateway. In the example of FIG. 2, a user 202 issues a GET request 204 to obtain the temperature of a boiler 234. Note that the GET request 204 is provided only by way of example. In embodiment, another GET request may extended to temperatures at multiple different points in time. An API 206 may receive the request and ask a fabric node 208 to find which host boiler 234 lives on, and the relevant routes. As shown in FIG. 2, ‘temperature’ is one route, but there may be others. For example, an additional, or alternate, route may be ‘boiler pressure.’ In response to the request from the API 206, the fabric node 208 may perform a lookup of the host information and route(s), and may return these, possibly as a JSON document, to the API 206. The API 206 may then validate that the route exists, and may then assemble its own HTTP request 210 to the appropriate host 212, that is, the host(s) on which the boiler 234 lives. Additional HTTP context such as, but not limited to, headers and querystring, may also be passed by the API 206 to the host 212, or target. The response of the host 212 to the query initiated by the user 202, that is, the GET request 204 in this example, may then be returned to the user 202 on the original HTTP connection that was initiated by the user 202.

These capabilities described in connection with FIG. 2 may allow functions to execute locally on edge devices, such as the boiler for example, and to manage local state, avoiding round trips to a centralized compute hub as in alternative FaaS approaches. Note that as used herein, ‘state’ is intended to be broadly construed, and may take various forms. For example, state may comprise, but is not limited to, the contents of a file, a sensor reading, or any other information that indicates a condition of a system such as an edge device, at a particular time or point in a chronology of events.

### C.2 Comparative Example and an Illustrative Embodiment

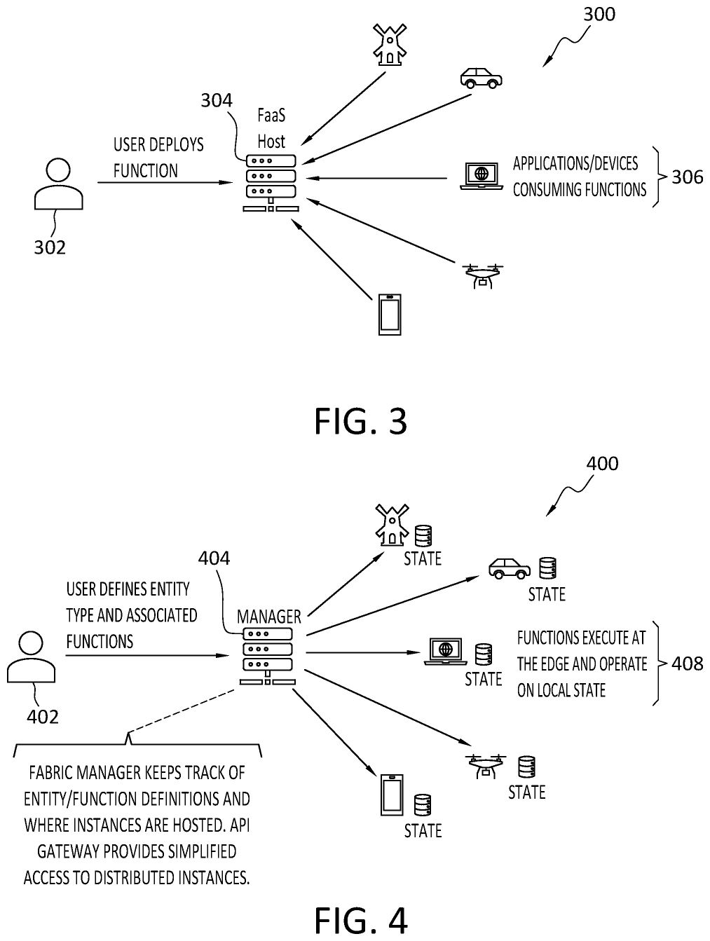

With reference now to FIGS. 3 and 4, a comparative example of a workflow 300 (FIG. 3) is disclosed that may help to illustrate various features and aspects of an of a workflow 400 (FIG. 4) according to an example embodiment of the invention. In the example of FIG. 3, a user 302 may deploy a function to an FaaS host 304. In general, the FaaS host 304 may provide centralized hosting and execution of functions, and the FaaS host 304 may also implement state persistence. These operations performed by the FaaS host 304 may create a chokepoint in the architecture that requires the development and implementation of strategies for scalability in the provision of functions to the various applications/devices 306 that consume the functions hosted by the FaaS 304.

By way of contrast, reference is now made to FIG. 4, which discloses an execution model according to one example embodiment. In the example of FIG. 4, a user 402 may define an entity type, such as a boiler for example, and associated functions, such as obtaining a boiler temperature for example. The entity type and functions may be provided by the user 402 to a fabric manager 404. The fabric manager 404 may keep track of the entity/function definitions provided by the user 402, and may also keep track of where, that is, at which entities, the instances of the functions are hosted. As explained in connection with FIG. 2, an API gateway (not shown in FIG. 4) may provide simplified access, for a user, to distributed instances of the functions. Thus, as indicated in FIG. 4, one or more functions may execute, and operate on local state, at each of one or more devices 408.

### C.3 Detailed Aspects of Function Definition and Deployment

Following is a detailed discussion of how functions, or capabilities, may be defined by a developer, in accordance with some embodiments. In an embodiment, the target, or device, programming language will be Go and fabric manager API operations may be facilitated by using Postman as the UI. Note that these languages and platforms are provided only by way of example, and are note intended to limit the scope of the invention.

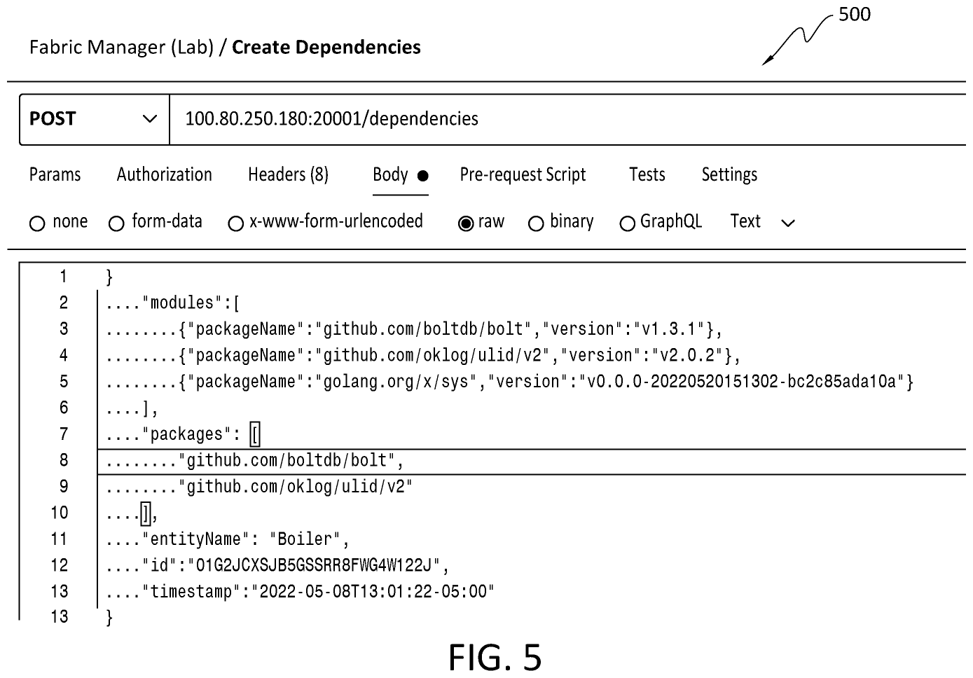

When considering a stateful entity, or type of entity, a determination may be made as to how the state will be persisted and loaded. For the purposes of illustration, and with reference now to the example of FIG. 5 which illustrates a process 500 for defining software dependencies for a stateful entity type, a simple key/value store called Bolt DB may be employed in one embodiment. Regardless of what a developer may choose to use, there will, in some embodiments at least, likely be dependencies required for inclusion in the final compiled application that will serve the function capabilities. Such dependencies may include, for example, dependencies between/among functions and/or applications. To illustrate, an application may require the use of a piece of third party code in order to operate properly. As such, the dependency of that application on that piece of third party code must be specified, and compiled into the application, in order for the application as a whole to operate properly. The fabric manager API may provide an endpoint whereby these dependencies can be defined and associated to a given entity type, such as a “boiler” in the illustrative example that has been referred to throughout this disclosure.

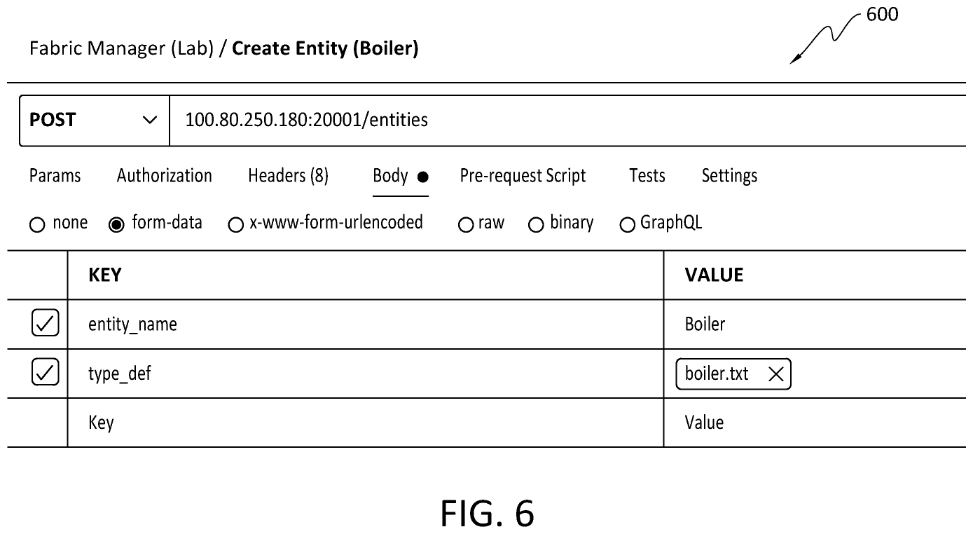

After the dependencies have been defined, a developer may upload code that defines the entity, such as a boiler for example, itself. This code may include the properties to be persisted as state, and their data types, as well as any methods which the developer might want to invoke on the entity from the subsequently defined functions. An example approach 600 to entity definition is disclosed in FIG. 6. Particularly, FIG. 6 discloses definition of a stateful entity type, itself. Note that in the example of FIG. 6, the actual entity type definition (see “Type_def” field) is handled as a file input, a text file in this case. This may allow the developer to work on code in their IDE of choice and then upload the file from their source tree when ready.

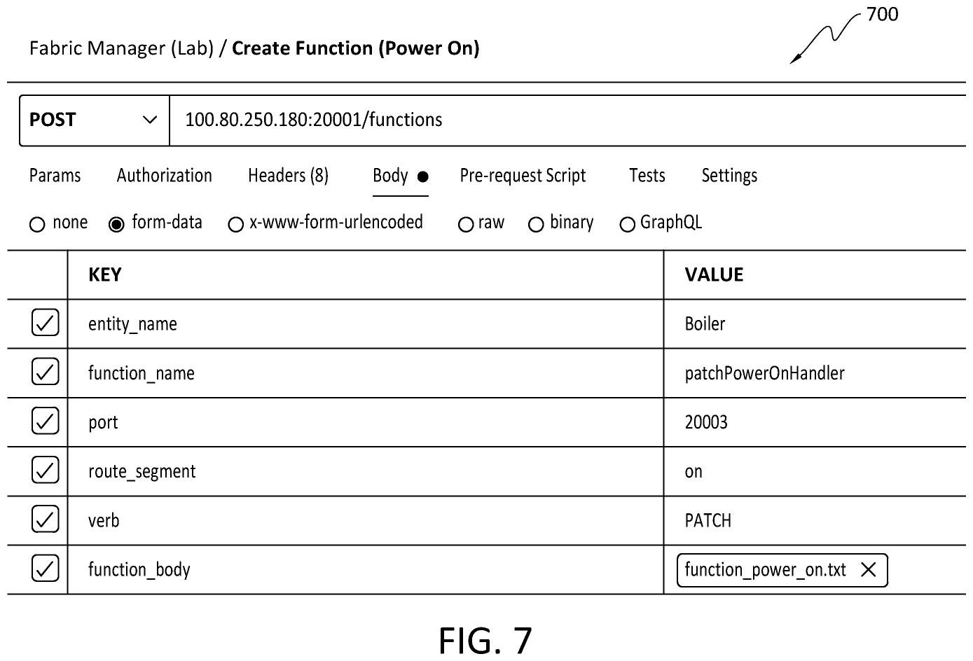

When any dependencies have been specified, and the entity type definition created/modified, a developer may then create one or more functions to execute at the entity. Particularly, a function, or functions, will be hosted on the actual device and may provide capabilities for remote invocation. In the illustrative case of a compute-enabled boiler, for example, it may be useful to be able to remotely turn the power to the boiler on. FIG. 7 discloses an example approach 700 for defining a function, “power on” in this example, for a stateful entity type, such as a boiler for example.

Particularly, the example of FIG. 7 shows how a POST request to the fabric manager API is used to create a new function. The target entity is specified, the function name is provided, along with the port to be used when calling the function and its route handler. The appropriate HTTP verb, PATCH in this case, is also specified. These elements allow the interaction (see FIG. 2) between the API gateway and the fabric manager and are used to assemble the request to the target device so that the function can be invoked.

Following is an example request to the API gateway seeking to turn on boiler 111: PATCH http://100.80.250.180:21000/instances/Boiler/111/on. Using the elements from FIG. 7, the fabric manager can look up where boiler 111 is hosted. The fabric manager may map the HTTP verb and the route segment to a function for entity type “boiler.” If all of these elements exist, the fabric manager may return the appropriate metadata to the API gateway where the request to the target device is assembled. The function may then be invoked on the target device, the boiler in this example, at the specified port and the response body, indicating that the boiler has been turned on, is returned to the original caller/user.

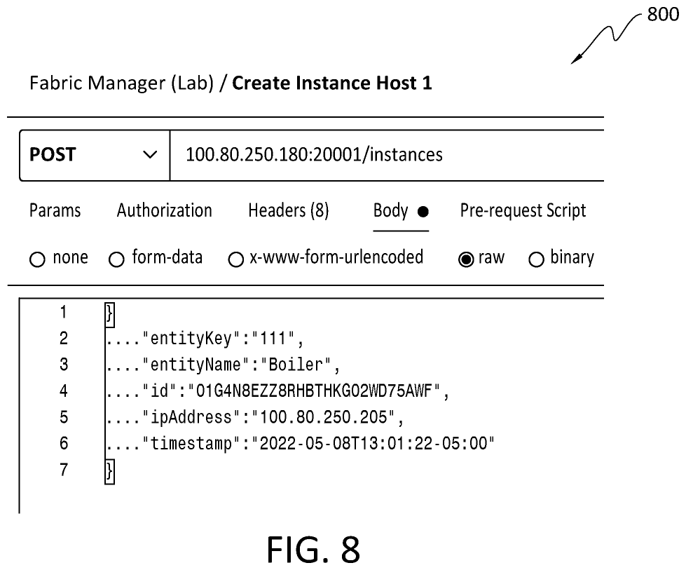

Note that in order for user-defined functions to be deployed, there must be entries in the fabric manager describing which entities are hosted where. This information may be provided manually or otherwise at the time of device onboarding. Either way, and as shown in the example of FIG. 8 which discloses a process 800 for onboarding an entity of type “boiler” on a given host, the fabric manager API endpoint may facilitate the activation of an entity within the fabric. As discussed below, once activated, and after a function has been deployed to the entity, the entity may respond to function calls from a user.

Particularly, the result of the various operations described above may be a compiled binary with a startup script that may be copied to the target device by the fabric manager. In one embodiment, this copy may be performed by way of the Linux SCP (secure copy) command. Recall that each user-defined function is its own application containing a simple web server that accepts requests on a specified port. To illustrate, if there were six user-defined functions for a given entity, then all hosts serving that entity would have six different processes running, one for each function.

After the fabric manager copies its files to the target, the fabric manager may run a launch script to start the application. The application may then continue to run, in a stateful manner, and serve user requests. Finally, an embodiment may provide for the monitoring of the health of the application.

### D. Further Discussion

As will be apparent from this disclosure, some example embodiments may provide a variety of useful features and functions. For example, in an embodiment, user-defined functions may be logically grouped so as to thereby specify a range of behavior for a given entity. As disclosed herein, at the time when a user-defined function is created, the function is associated with a given entity type, such as a boiler for example. This association may enable a developer to extend the software capabilities of the entity and, thus, the device where the entity is hosted. This relationship between an entity and its function(s) may be thought of as being similar to that of the relationship of a class to its methods, that is, one or more methods may belong to a particular class. As another example, in an embodiment, functionally-defined entities are directly addressable by ID. Particularly, when an entity is hosted on a given device, an ID is assigned to the entity which in turn allows the entity to be addressable in the URL. As disclosed herein, this ID allows a calling application or user to target the entity and its functions. The ID is provided as part of the initial request to the API gateway, which then uses the fabric manager to determine locality.

Further, embodiments may create and deploy stateful functions for use in an edge computing environment. To continue with the method-class analogy, when a class is instantiated as an object, the class has an internal representation of its state. That state may be mutable by callers or internal logic, and then persisted in a store. Some embodiments provide the ability for a functionally-defined entity to operationalize and persist its state locally where the functions are running. A snapshot of this state may be exposed to callers, such as for reporting or analytics.

As another example, embodiments may enable functions to execute directly on an edge device rather than at a centralized compute node. Each function is itself a full application running on the host device itself. This may be similar to containerized FaaS platforms except that example embodiments of the invention avoid the need for, and overhead of, container orchestration. Rather, according to some example embodiments, these simple application-based functions run directly on the target device. Thus, a compute-enabled edge device, such as a boiler or a pump for example, hosts functions such as those disclosed herein, and the functions are in turn associated to an entity type that is the boiler or pump.

Finally, embodiments may be configured so that functions are deployed without containers, running as native processes on a host. In one implementation, functions are deployed as small web server applications. However other transport mechanisms, such as pub/sub to a specific topic, could also be used. These applications run as native processes and do not require the overhead of container platforms. This approach provides a smaller footprint for potentially compute-resource limited edge devices. Further, embodiments may also preferentially employ compiled languages over interpreted code for performance reasons, as well as for the elimination of runtimes that would be required to parse interpreted code.

### E. Example Methods

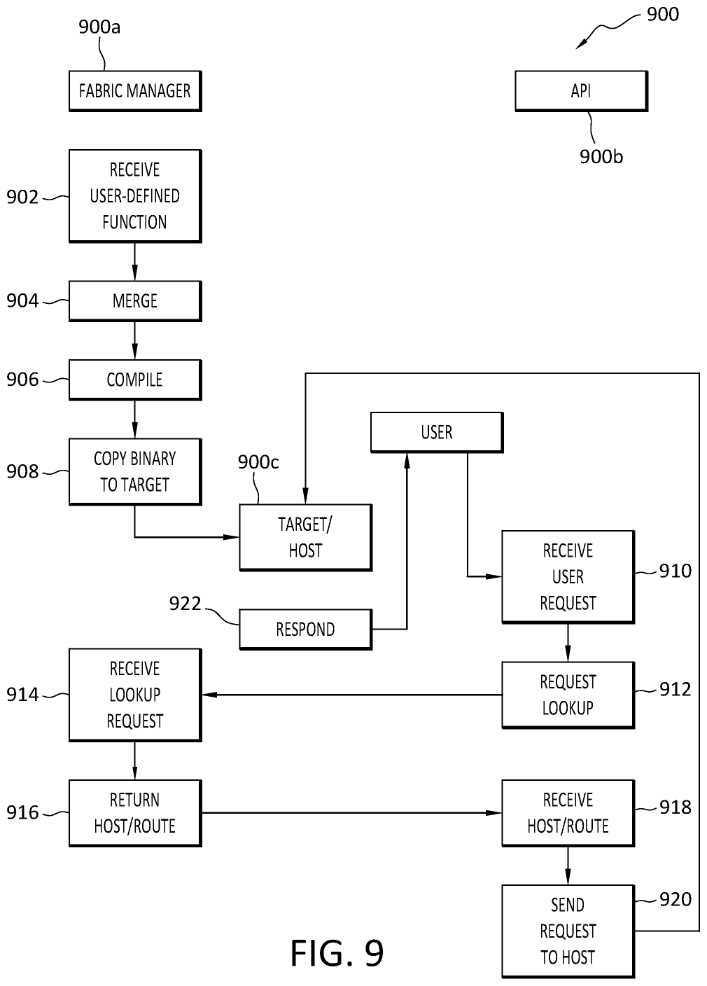

It is noted with respect to the disclosed methods, including the example method of FIG. 9, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 9, a method according to one example embodiment is denoted generally at 900. As shown in FIG. 9, various entities may perform different aspects of the method 900, and such entities may include, but are not limited to, a fabric manager 900a, an API gateway 900b, and a host device 900c. Note that the functional allocation as amongst these entities is provide only by way of example and is not intended to limit the scope of the invention in any way. In other embodiments, the functions disclosed in FIG. 9, and elsewhere herein, may be allocated differently than what is indicated in FIG. 9.

The example method 900 may begin when the fabric manager 900a receives 902 a user-defined function. The fabric manager 900a may merge 904 the function into a script template that includes an application hosting a web server. A compilation process may then be performed 906 on the merged function and script template, and a resulting binary then copied 908 to the target/host physical device 900c, which may take the form, for example, of a boiler or pump.

At some point after the function has been provided to the target/host, the API gateway 900b may receive 910 a request, such as a GET, from a user. In response to the user request, the API gateway 900b may request 912 a lookup from the fabric manager 900a. The fabric manager 900a may then receive 914 the lookup request, and perform the lookup to obtain information such as the host ID and route(s). This information may then be returned 916 by the fabric manager 900a to the API gateway 900c. The API gateway 900b may then receive 918 the information from the fabric manager 900a and then generate and transmit 920 a request to the target/host 900c for the information needed by the user. The target/host 900c may then transmit a response body 922 back to the requesting user.

### F. Further Example Embodiments

Following are some further example embodiments of the invention. These are presented only by way of example and are not intended to limit the scope of the invention in any way.

Embodiment 1. A method, comprising: receiving a user-defined function; generating a binary based on the user-defined function; copying the binary to a target host where the user-defined function will run; in response to a lookup request, received from an API gateway based on a function invocation by a user, looking up the target host and a route; and returning, to the API gateway, a target host ID and the route, so as to enable the API gateway to request the target host to respond to the function invocation.

Embodiment 2. The method as recited in claim 1, wherein the user-defined function is configured to run in a stateful manner at the target host.

Embodiment 3. The method as recited in claim 1, wherein the receiving, generating, and copying, are performed by a fabric manager configured to communicate with the API gateway.

Embodiment 4. The method as recited in claim 1, wherein when the user-defined function is created, it is associated with a specific entity type.

Embodiment 5. The method as recited in claim 1, wherein an entity associated with the target host is directly addressable by a unique identifier.

Embodiment 6. The method as recited in claim 1, wherein the function is operable to run directly on the target host.

Embodiment 7. The method as recited in claim 1, wherein the function is deployed to, and executable on, the target host without necessitating use of a container.

Embodiment 8. The method as recited in claim 1, wherein a target host response to the function invocation by the user comprises a response body with information specified in the function invocation.

Embodiment 9. The method as recited in claim 1, wherein when the target host is onboarded in a fabric, in which a fabric manager operates, the target host is able to receive any existing functions that could be invoked, based on their respective function type, for that target host.

Embodiment 10. The method as recited in claim 1, wherein an entity associated with the target host is directly addressable, even when a physical location of the entity is unknown.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

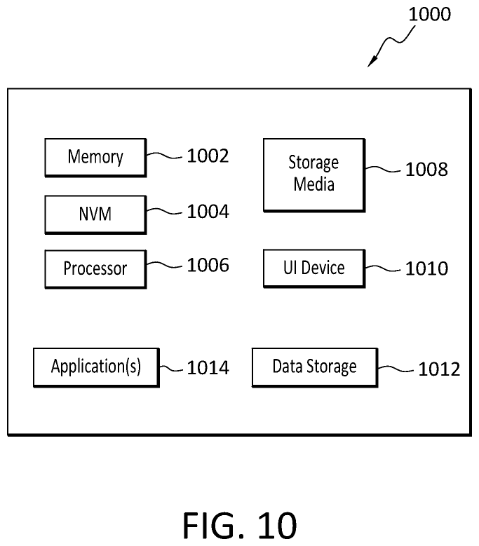

With reference briefly now to FIG. 10, any one or more of the entities disclosed, or implied, by FIGS. 1-9 and/or elsewhere herein, may take the form of, or include, or be implemented on, or hosted by, a physical computing device, one example of which is denoted at 1000. As well, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile memory (NVM) 1004 such as NVRAM for example, read-only memory (ROM), and persistent memory, one or more hardware processors 1006, non-transitory storage media 1008, UI (user interface) device 1010, and data storage 1012. One or more of the memory components 1002 of the physical computing device 1000 may take the form of solid state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a user-defined function;
generating a binary based on the user-defined function;
copying the binary to a target host where the user-defined function will run;
in response to a lookup request, received from an API gateway based on a function invocation by a user, looking up the target host and a route; and
returning, to the API gateway, a target host ID and the route, so as to enable the API gateway to request the target host to respond to the function invocation.

2. The method as recited in claim 1, wherein the user-defined function is configured to run in a stateful manner at the target host.

3. The method as recited in claim 1, wherein the receiving, generating, and copying, are performed by a fabric manager configured to communicate with the API gateway.

4. The method as recited in claim 1, wherein when the user-defined function is created, it is associated with a specific entity type.

5. The method as recited in claim 1, wherein an entity associated with the target host is directly addressable by a unique identifier.

6. The method as recited in claim 1, wherein the function is operable to run directly on the target host.

7. The method as recited in claim 1, wherein the function is deployed to, and executable on, the target host without necessitating use of a container.

8. The method as recited in claim 1, wherein a target host response to the function invocation by the user comprises a response body with information specified in the function invocation.

9. The method as recited in claim 1, wherein when the target host is onboarded in a fabric, in which a fabric manager operates, the target host is able to receive any existing functions that could be invoked, based on their respective function type, for that target host.

10. The method as recited in claim 1, wherein an entity associated with the target host is directly addressable, even when a physical location of the entity is unknown.

11. A non-transitory storage medium having stored therein instructions that are executable by one or more hardware processors to perform operations comprising:
receiving a user-defined function;
generating a binary based on the user-defined function;
copying the binary to a target host where the user-defined function will run;
in response to a lookup request, received from an API gateway based on a function invocation by a user, looking up the target host and a route; and
returning, to the API gateway, a target host ID and the route, so as to enable the API gateway to request the target host to respond to the function invocation.

12. The non-transitory storage medium as recited in claim 11, wherein the user-defined function is configured to run in a stateful manner at the target host.

13. The non-transitory storage medium as recited in claim 11, wherein the receiving, generating, and copying, are performed by a fabric manager configured to communicate with the API gateway.

14. The non-transitory storage medium as recited in claim 11, wherein when the user-defined function is created, it is associated with a specific entity type.

15. The non-transitory storage medium as recited in claim 11, wherein an entity associated with the target host is directly addressable by a unique identifier.

16. The non-transitory storage medium as recited in claim 11, wherein the function is operable to run directly on the target host.

17. The non-transitory storage medium as recited in claim 11, wherein the function is deployed to, and executable on, the target host without necessitating use of a container.

18. The non-transitory storage medium as recited in claim 11, wherein a target host response to the function invocation by the user comprises a response body with information specified in the function invocation.

19. The non-transitory storage medium as recited in claim 11, wherein when the target host is onboarded in a fabric, in which a fabric manager operates, the target host is able to receive any existing functions that could be invoked, based on their respective function type, for that target host.

20. The non-transitory storage medium as recited in claim 11, wherein an entity associated with the target host is directly addressable, even when a physical location of the entity is unknown.
